(19) United States
(12) Patent Application Publication
(10) Pub. No.: US 2014/0074583 A1
(43) Pub. Date: Mar. 13, 2014

(54) METHOD AND APPARATUS FOR OPERATING A WEBSITE

(71) Applicants: Nicholas J. Harvey, Canal Fulton, OH (US); Christopher J. Ippolito, Canton, OH (US)

(72) Inventors: Nicholas J. Harvey, Canal Fulton, OH (US); Christopher J. Ippolito, Canton, OH (US)

(73) Assignee: NICER AND AFFILIATES, LTD., Canal Fulton, OH (US)

(21) Appl. No.: 13/608,685

(22) Filed: Sep. 10, 2012

(51) Int. Cl. G06Q 30/06; G06Q 30/02

(52) U.S. Cl. 705/14.39; 705/26.2

(57) ABSTRACT

The present invention includes a social networking system wherein the users may be broadly categorized as payor users or payee users. Payor users are generally individuals or students, while payee users generally businesses or charities. Each user in the social networking system of the present invention is associated with financial data. The financial data is thereafter used to facilitate commercial transactions and transfer donations within the social networking system between users, generally from a payee user to a payor user. The payor user is not required to enter financial data or log in to an additional system to facilitate the transaction. The transaction is facilitated entirely within the constructs of the social networking system. Pursuant to this, payee users may add products and services to their associated profiles to vend their products and services from within the social networking system.

### BACKGROUND OF THE INVENTION

1. Technical Field

This invention relates generally to social networking systems and other websites in which users can form connections with other users. More particularly, this invention relates to a social networking system which facilitates commercial transactions between the users within the social network. Specifically, users of the social network are partitioned generally into a set of payor users and a set of payee users, whereby payee users display and vend goods and services for purchase by payor users, and the related financial transactions are facilitated through and within the social networking system.

2. Background Information

A social networking system is an online service, platform, or site that focuses on building and reflecting of social networks or social relations among people, who, for example, share interests and/or activities. A social networking system consists of a representation of each user, often a profile, his/her social links, and a variety of additional services. Most social networking systems are web-based and provide means for users to interact over the Internet, such as e-mail and instant messaging. Online community services are sometimes considered as a social networking system, though in a broader sense, social networking system usually means an individual-centered service whereas online community services are group-centered. Social networking sites allow users to share ideas, activities, events, and interests within their individual networks.

Social networking systems share a variety of technical features. The most basic of these are visible profiles with a list of “friends” who are also users of the site. In an article entitled “Social Network Sites: Definition, History, and Scholarship,” Boyd and Ellison adopt Sunden's (2003) description of profiles as unique pages where one can “type oneself into being.” A profile is generated from answers to questions, such as age, location, interests, etc. Some sites allow users to upload pictures, add multimedia content or modify the look and feel of the profile. Others, e.g., Facebook, allow users to enhance their profile by adding modules or “applications.” Many sites allow users to post blog entries, search for others with similar interests and compile and share lists of contacts. User profiles often have a section dedicated to comments from friends and other users. To protect user privacy, social networks typically have controls that allow users to choose who can view their profile, contact them, add them to their list of contacts, and so on.

As the increase in popularity of social networking is on a constant rise, new uses for the technology are constantly being observed. Companies have begun to merge business technologies and solutions, such as cloud computing, with social networking concepts. Instead of connecting individuals based on social interest, companies are developing interactive communities that connect individuals based on shared business needs or experiences. Many provide specialized networking tools and applications that can be accessed via their websites, such as LinkedIn. Others companies, such as Monster.com, have been steadily developing a more “socialized” feel to their career center sites to harness some of the power of social networking sites. These more business related sites have their own nomenclature for the most part but the most common naming conventions are “Vocational Networking Sites” or “Vocational Media Networks”, with the former more closely tied to individual networking relationships based on social networking principles. One popular use for this new technology is social networking between businesses. Companies have found that social networking sites such as Facebook and Twitter are great ways to build their brand image. According to Jody Nimetz, author of Marketing Jive, there are five major uses for businesses and social media: to create brand awareness, as an online reputation management tool, for recruiting, to learn about new technologies and competitors, and as a lead generation tool to intercept potential prospects. These companies are able to drive traffic to their own online sites while encouraging their consumers and clients to have discussions on how to improve or change products or services.

Business applications for social networking sites have extended toward businesses creating their own, high functioning sites, a sector known as brand networking. It is the idea a brand can build its consumer relationship by connecting their consumers to the brand image on a platform that provides them relative content, elements of participation, and a ranking or score system. Brand networking is a new way to capitalize on social trends as a marketing tool. However, at present, a framework does not exist for incorporating financial transactions between users within a social networking system. Thus, while businesses may create a brand profile and establish a presence within a social networking system, heretofore businesses could not go beyond this simple presence into real world business transactions with respect to buying and selling of goods through the profile and social networking system. Therefore, a great need exists in the art for a social networking system framework which facilitates financial transactions between users without additional logging in or passwords, or any additional steps beyond signing into the social networking system.

### BRIEF SUMMARY OF THE INVENTION

The present invention includes a method and apparatus of facilitating a social networking system. The method of facilitating a social networking system includes the step of creating a pool of users for the social networking system, wherein each user is associated with a set of public data, a set of financial data, and a profile for displaying the set of public data. The method further includes the steps of partitioning the pool of users into a group of general users, a group of student users, a group of business users, and a group of charity users and allowing the group of general users and the group of student users to selectively purchase a product from the group of business users through the social networking system. The method further includes the step of allowing the group of general users and the group of student users to selectively transfer a donation to the group of charity users through the social networking system.

The apparatus for facilitating a social networking system includes one or more processors and a memory comprising instructions executable by the one or more processors. The one or more processors are coupled to the memory and operable to execute instructions. These instructions are directed to maintain a set of payor users of the social networking system; maintain a set of payee users of the social networking system; associate a payor financial dataset for each payor user; and use the payor financial datasets to provide payments to payee users as requested.

### BRIEF DESCRIPTION OF THE SEVERAL VIEWS OF THE DRAWINGS

A preferred embodiment of the invention, illustrated of the best mode in which Applicant contemplates applying the principles, is set forth in the following description and is shown in the drawings and is particularly and distinctly pointed out and set forth in the appended claims.

FIG. 1 depicts two computers interconnected via the Internet, one of which is a server connected to a database, and the other of which represents a user's client workstation, both of which are configured according to the prior art;

FIG. 2 depicts a pool of users within the social networking system of the present invention, with an individual user shown as being associated with a profile;

FIG. 3 represents a user table and a user-type table in a relational database maintained on the server computer in the preferred embodiment of the present invention;

FIG. 4 represents a data flow diagram of a method of adding a user to the social networking system of the present invention;

FIG. 5 represents a pseudo graphical interface for a profile layout of the present invention;

FIG. 6 represents a data flow diagram for determining what data to display within a profile of the social networking system of the present invention;

FIG. 7 is a data flow diagram for a method of adding a product to the relational database maintained on the server computer in the preferred embodiment of the present invention;

FIG. 8 represents a data flow diagram for a method of browsing and interacting with profiles displayed in the social networking system of the present invention;

FIG. 9 represents a data flow diagram of a first checkout procedure method available in the social networking system of the present invention; and

FIG. 10 represents a data flow diagram of a second checkout procedure of the present invention.

Similar numbers refer to similar parts throughout the drawings.

### DETAILED DESCRIPTION OF THE INVENTION

Reference will now be made in detail to the preferred embodiments of the invention, examples of which are illustrated in the accompanying figures. While the invention will be described in conjunction with the preferred embodiments, it will be understood that they are not intended to limit the invention to those embodiments. On the contrary, the invention is intended to cover alternatives, modifications, and equivalents, which may be included within the spirit and scope of the invention as defined by the appended claims.

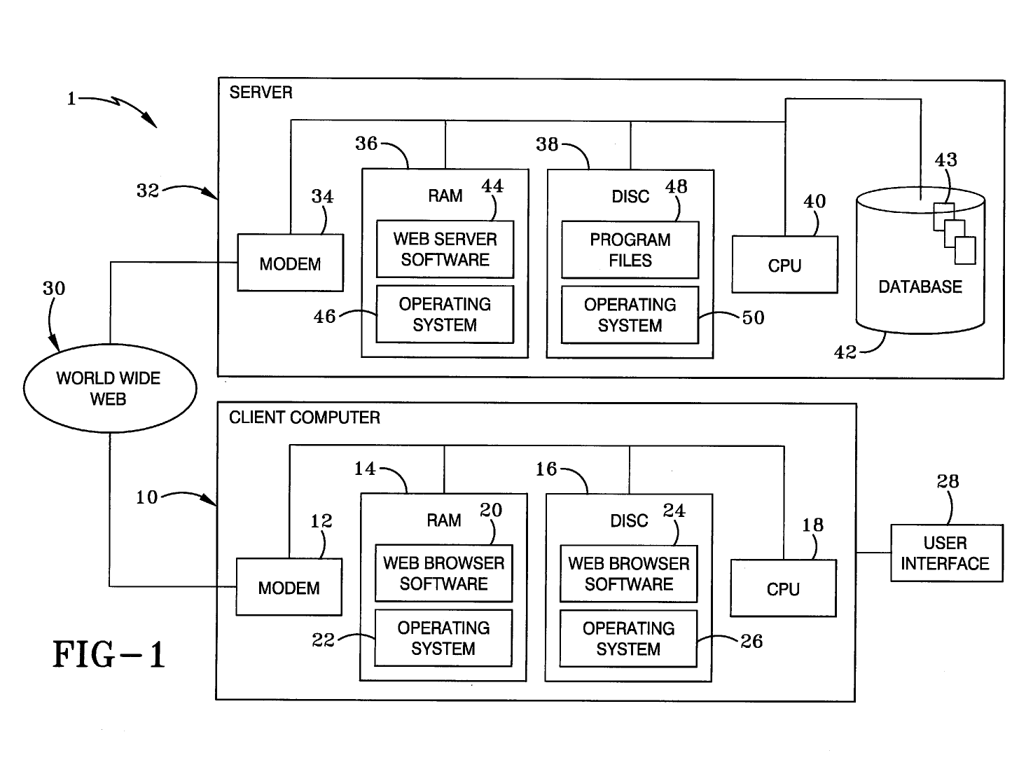

As represented in FIG. 1, a method and apparatus for operating a website is now described herein as a social networking system 1. The preferred embodiment of social networking system 1 follows a standard Internet architecture, in which at least one client computer 10 and a server computer 32 are connected via the World Wide Web 30 via a modem 12 of client computer 10 communicating with a modem 34 of server computer 32, or via any other common communication channels. A user accesses server computer 32 via client computer 10 operating a web browser 20 or other software application residing in a random access memory 14 that allows client computer 10 to display information downloaded from server computer 32. Server computer 32 runs web server software 44 residing in a random access memory 36 and which interacts with client computer 10 and a database 42. Database 42 contains information relating to users of social networking system 1 and the supporting data used to facilitate and run social networking system 1. Database 42 is a relational database built from a set of relational tables 43. In the conventional manner, both server computer 32 and client computer 10 include respective storage devices, such as a hard disk 38 and 16, respectively, and operate under the control of an operating system 50 and 26, respectively, executed in random access memory 36 and 14, respectively, by a central processor unit 40 and 18, respectively. Hard drive 38 of server computer 32 stores a set of program files 48 and an operating system 50. Similarly, the hard drive 16 of client computer 10 stores a web browser software 24 and an operating system 26 used in the operation of client computer 10.

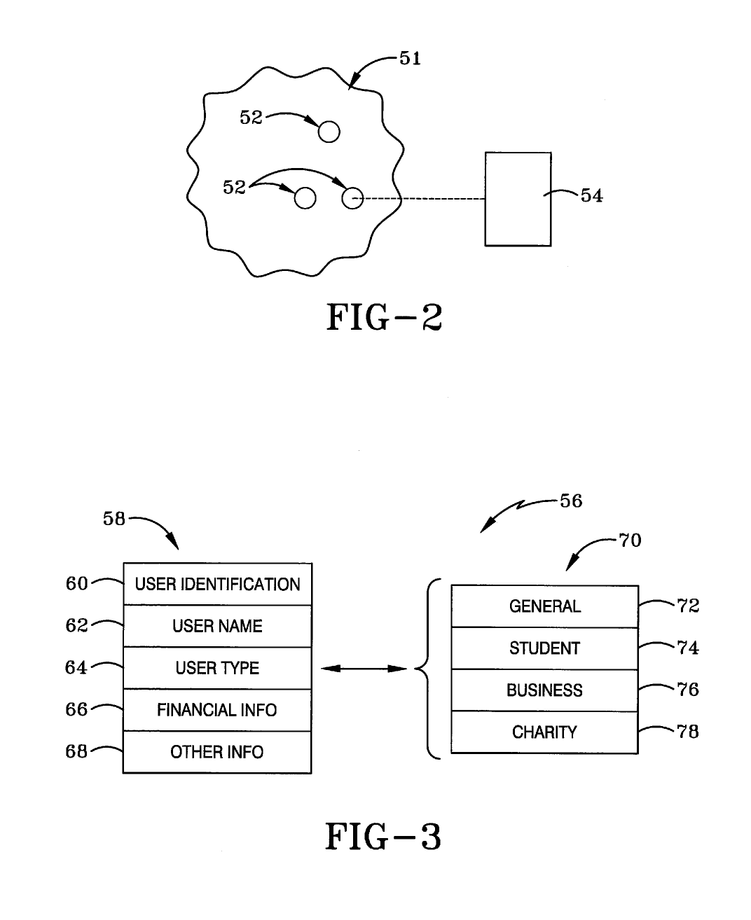

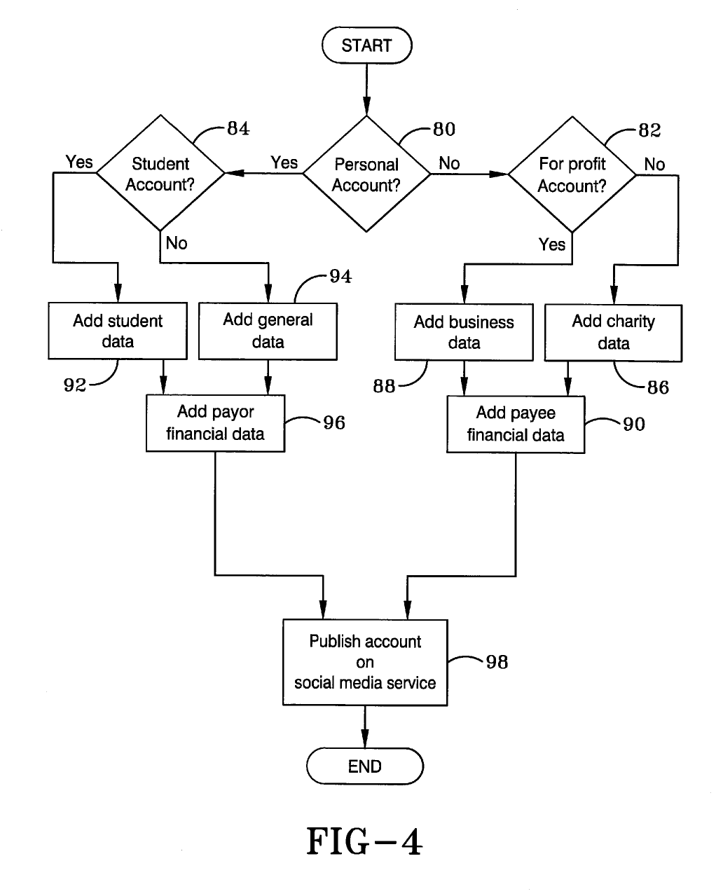

As shown in FIGS. 2 and 3, social networking system 1 facilitates the creation and maintenance of a pool 51 of users 52 of the social networking system 1. Each user 52 includes a profile 54 based on a profile template 55. Each profile 54 is viewable by each other user 52 in pool 51. Each user 52 is associated with data files 56 stored in database 42, generally corresponding with a user table 58 data structure for storing at least a user identification number 60, a name 62, a user type 64, and a financial information 66 related to each user 52. Social networking system 1 facilitates two users 52 forming associations therebetween, such that the association enables social interactions between the two users 52 with the association. For example, the association enables posting comments on photographs, sending private messages, applying comments or photographs to the profile 54 of the other user 52 with the association. One or more elements for storing at least other information 68 is also available in user table 58. The user type 64 field is populated with a link to another one of the data files 56 stored in database 42, generally corresponding with a user type table 70 data structure for storing the available user types. In the preferred embodiment, user type table 70 includes four user types 64. The available user types 64 in the preferred embodiment are a general or primary user type 72, a student user type 74, a business user type 76, and a charity user type 78. Profile template 55 retrieves data from data files 56 stored in database 42 and populates the associated profile 54 therefrom.

It is a primary feature of social networking system 1 that the preferred embodiment of the present invention includes user type 72, student user type 74, business user type 76, and charity user type 78. It is intended that all users 52 of social networking system 1 can be categorized within one of these four user types 64. Within these four user types 64, user type 72 and student user type 74 may be broadly construed to correspond to a payor type of user, whereby a payor style user makes payments to other users 52 of social networking system 51. Conversely, business user type 76 and charity user type 78 generally correspond to a payee style user, whereby payee users receive payments from payor users within social networking system 1. Thus, it is another primary feature of the present invention that payor users may transfer payments to payee users within social networking system 1. Pursuant to this, social networking system 1 collects financial information 66 for all users 52. However, payor style financial information is collected for general user type 72 and student user type 74, and payee style financial information is collected for business user type 76 and charity user type 78.

General user type 72 is the default form of a user 52 of social networking system 1. As discussed above, general user type 72 corresponds to a payor style user of social networking system 1. Thus, payor style financial information 66 is stored for each user 52 which is designated as a general user type 72. Similar to general user type 72, student user type 74 is also a payor style user 52, with additional information included to verify and signify any user 52 which includes a student user type 74 as a student. User 52 designated as student user type 74 may be a student of a university, a college, a high school, or any other style learning institution which may be designated by social networking system 1. It is intended that any user 52 with student user type 74 automatically qualifies for certain discounts or other marketing opportunities within social networking system 1. Thus, student user type 74 may be thought of as a subcategory of general user type 72.

As discussed above, business user type 76 generally corresponds to a payee style user 52 within social networking system 1. As such, social networking system 1 collects payee style financial information 66 for business user type 76 such as a bank routing number for a deposit account for accounts receivable or other money collecting accounts. Any user 52 designated as a business user type 76 may also display and promote products or services on the corresponding profile 54 for that user 52 designated as a business user type 76. It is intended that all users 52 designated as a business user type 76 gain access to additional features and additional views and layouts of social networking system 1 allowing these users to upload and maintain a virtual storefront to their business, complete with photographs of products, inventory numbers, and pricing information. Inasmuch as all payor style users 52 include financial information 66 associated therewith, each payor style user 52 within social networking system 1 may purchase products and services directly through social networking system 1 by viewing and purchasing items through profile 54 of users 52 categorized as a business user type 76.

As discussed above, users 52 may be designated as charity user type 78, which is generally categorized as a payee within social networking system 1. Charity user type 78 is similar to business user type 76 in that charity user type 78 may upload and display elements which a payor user 52 may wish to purchase or donate in such a way that charity user type 76 receives the benefits or proceeds from this interaction. A typical interaction between either a general user type 72 or a student user type 74 with a charity user type 78 is one in which the charity user type 78 is soliciting donations for a particular fund or event. Any interested user 52 within the general user type 72 or student user type 74 may then donate through social networking system 1 to the charity user type 78 as desired. Social networking system 1 facilitates this interaction by utilizing financial information 66 stored for general user type 72 or student user type 74 to transfer funds from these users to the charity user type 78. Users 52a wishing to donate to their desired charity simply click on profile 54 of the desired charity user 52c and follow instructions on profile 54 to donate funds thereto. User 52a does not have to remember or enter separate login or financial data to transfer funds to the desired charity user 52c, social networking system 1 facilitates this seamlessly in the background by way of the stored financial information 66 for both entities. Thus, it is a primary feature of the present invention that users 52 of social networking system 1 do not have to log in individually to different businesses or charities to transfer funds thereto. All funds transfers may be done within social networking system 1 without the need to separately log in to each business or charity, or enter financial information for such financial transactions.

As shown in FIG. 4, a new user 52a is added to social networking system 1 by first determining in a step 80 whether new user 52a desires an account. If step 80 determines user 52a does not desire an account, step 80 proceeds to a step 82. In the alternative, if step 80 determines user 52a does desire an account, step 80 proceeds to a step 84. Step 82 determines whether user 52a desires a for-profit account. If step 82 determines user 52a does not desire a for-profit account, step 82 proceeds to a step 86, where charity data is requested and entered into data files 56. Step 86 includes creating a user table 58a for user 52a and setting a user type 64a of user table 58a to charity user type 78 to indicate user 52a is a charity organization. In the alternative, if step 82 determines user 52a does desire a for-profit account, step 82 proceeds to a step 88, where business data is requested and entered into data files 56. Step 88 includes creating user table 58a for user 52a and setting user type 64a of user table 58a to business user type 78 to indicate user 52a is a business. Thereafter, both step 86 and step 88 proceed to a step 90, where payee financial data is requested and entered into a financial information 66a field of user table 58a. Payee financial data includes data for facilitating the receiving of payments from any one of the users 52 in social networking system 1. Thereafter, step 90 proceeds to a step 92, wherein a profile 54a is created for user 52a and published on social networking system 1 for all other users 52 to view and interact with.

Step 84 determines whether user 52a qualifies for a student account. If user 52a qualifies for a student account, step 84 proceeds to a step 92, where student data specific is collected. Step 92 includes creating user table 58a for user 52a and setting user type 64a of user table 58a to student user type 74 to indicate user 52a is a student style account within the framework of social networking system 1. If step 84 determines that user 52a does not qualify for a student account, step 84 proceeds to a step 94, where general data is requested and entered into data files 56. Similar to step 92, step 94 includes creating user table 58a for user 52a and setting user type 64a of user table 58a to general user type 72 to indicate user 52a is a general style account within the framework of social networking system 1. Thereafter, both step 92 and step 94 proceed to a step 96, where payor financial data is requested and entered into financial information 66a field of user table 58a. Payor financial data includes data for facilitating sending payments from user 52a to any of the other users in social networking system 1. Thereafter, step 96 proceeds to a step 98, wherein profile 54a is created for user 52a and published on social networking system 1 for all other users 52 to view and interact with.

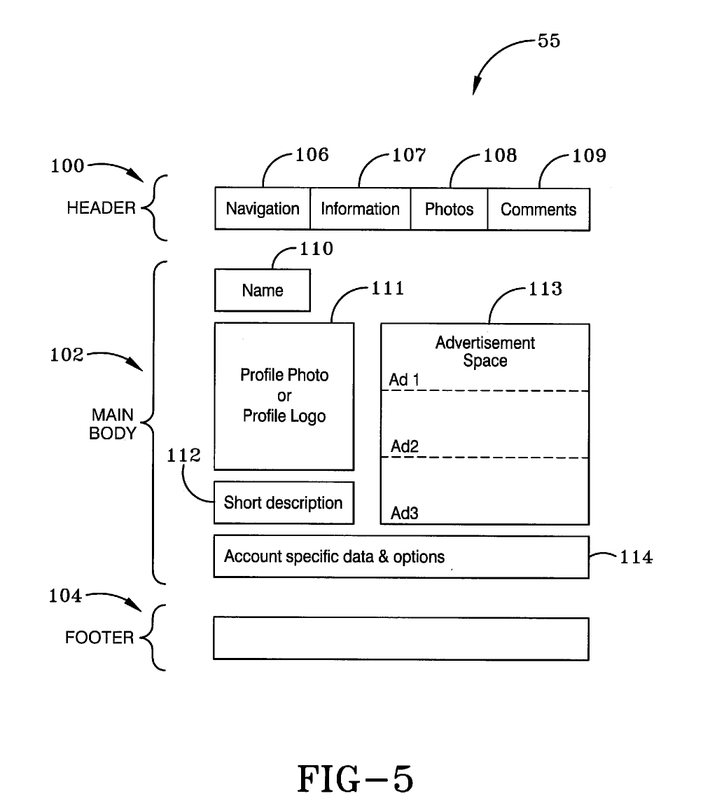

FIG. 5 represents a pseudo graphical user interface for displaying an individual profile 54 associated with the corresponding user 52 of social networking system 1. It will readily be understood by those familiar with the art that profile 54 and the arrangement of data elements thereon may be customized and changed as desired by the administrators of social networking system 1, and may even change over time due to updated styles or a subsequent release or overhaul of the general look of profile 54 and the esthetic features of social networking system 1. Profile 54 is generally portrayed within web browser software 20 on client computer 10 through client server interaction of social networking system 1 through World Wide Web 30. Thus, when any user 52 is browsing or interacting with profile 54, the same general layout and style for each user 52 of social networking system 1 is generally portrayed through this same profile 54 template. The representative pseudo template of profile 54 is shown in FIG. 5, and generally includes a header 100, a main body 102, and a footer 104. Header 100 may include elements such as a navigation element 106 for moving to different profiles or other sections within social networking system 1. Header 100 may also include an information element 107 for providing various information on the particular user 52 associated with the currently displayed profile 54. Header 100 may also include a photo element 108 for viewing photographs or images associated with the currently displayed profile 54. Header 100 may also include a comments section 109 for adding comments to the currently displayed profile 54 or reviewing previously submitted comments. Main body 102 includes various elements for displaying information about user 52 such as a name 110, a graphic 111, a short description 112, and account specific data and options 114. Graphic 111 may include a profile photo or a logo depending upon the style of user 52. For example, if user 52 includes a business user type 76 entered in user type 64 field within user table 58, graphic 111 may display that business's logo or other identifying graphic, such as the company's trademark. Conversely, if user 52 is a student, as indicated by having student user type 74 entered in user table 58, graphic 111 may display a photograph of the face of user 52. Likewise, name 110 and short description 112 may also be customized to include information such as a business name if user 52 is a business or a person's personal first and last name if user 52 is a primary style user or student style user. Account specific data and options 114 may be customized per user type to provide targeted features useful to each user type. For example, if profile 54 relates to an underlying user 52 which is designated as a charity, having charity user type 78 in user table 58, account specific data and options 114 may provide information for donating to this particular charity. Account specific data and options 114 is therefore customizable per user type. Main body 102 further includes an advertisement space 113 for displaying targeted ads to a browser of this profile. Advertisement space 113 may include discount or sale announcements and may be selected specifically to cater to the tastes of the browsing user 52 based on algorithms commonly known in the art. Conversely, advertisement space 113 may be related directly to profile 54 in that if profile 54 is a business style user, advertisement space 113 may portray ads or marketing material specific to the underlying business. Profile 54 may also include footer 102 for any miscellaneous use within social networking system 1, such as contact information for the owners of social networking system 1, or customer service information. While the size, placement, and available elements on profile 54 within social networking system 1 are determined by the administrators of social networking system 1, it is a primary feature of the present invention that the overall template and structure is static for every profile 54 within social networking system 1. Therefore, whether users 52 are browsing a business style profile 54 or a charity style profile 54, or other primary style or student style profiles 54, the overall profile template 55 is standardized for every individual profile to be displayed. As such, a user browsing across a variety of styles of profiles 54 encounters each profile 54 in the same structure having the same overall look. This lends itself to providing an esthetically pleasing experience for users 52 of social networking system 1, in that the placement of links and information is generally located in the same area for each profile 54, thus increasing the usability of social networking system 1. For example, a browsing user 52 will always encounter graphic 111 in the same general location on each profile 54, whether the underlying user 52 is a primary style user, a student style user, a business style user, or a charity style user. Thus, a user is prevented from having to learn where each link and each subsection of each profile is located when moving through social networking system 1, as all of the profile elements are generally located in the same area for each profile 54.

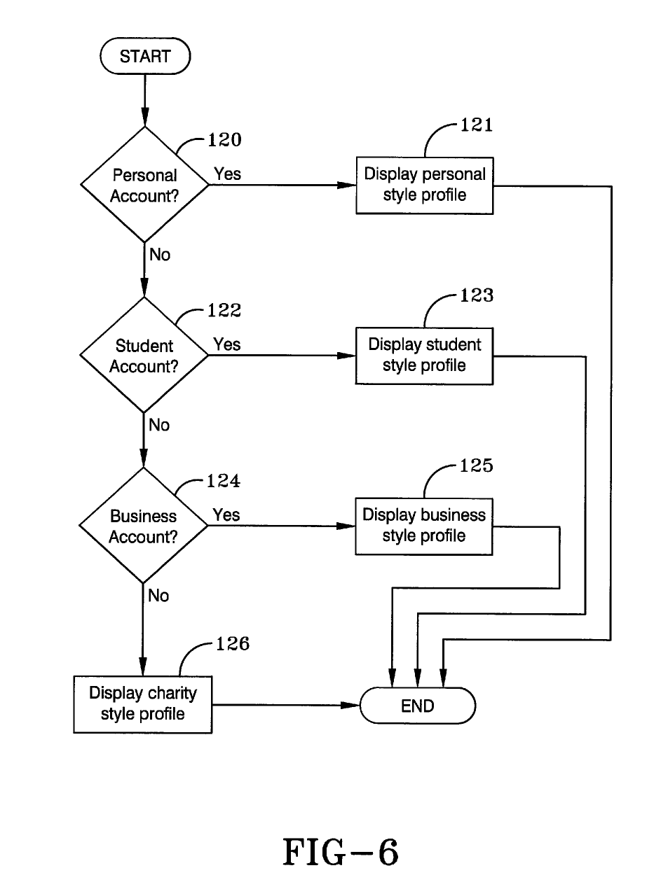

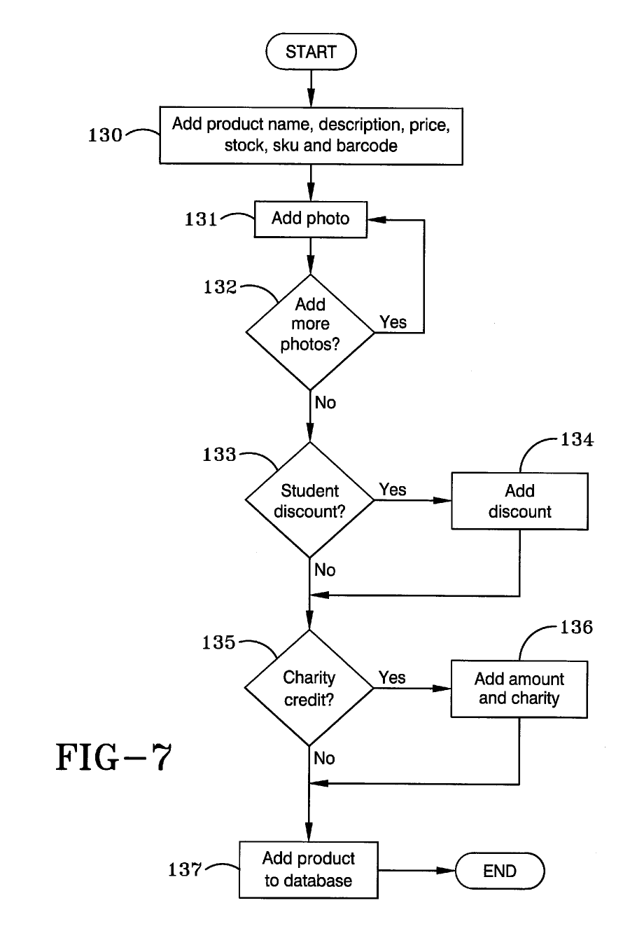

As shown in FIG. 6, social networking system 1 includes a procedure for determining what information to include and display on a particular profile 54. This data retrieval is based primarily off of the user type field 64 within the user table 58 for the particular user 52 corresponding to the profile 54 being observed. The data flow diagram of FIG. 6 is employed when a browsing user 52a clicks on a particular profile 54, corresponding to an underlying user 52b. The procedure for determining what information is displayed on this profile 54 begins with a step 120 for determining whether the underlying user 52b is a personal or general style user account, which is determined by checking the user type field 64 within the user table 58 of user 52b. If user type field 64 is populated with a general user type 72, step 120 proceeds to a step 121 wherein social networking system 1 displays a personal style profile 54, which includes populating the various elements within profile template 55 with personal style information relating to user 52b. If step 120 determines that user type 64 is not populated by general user type 72, step 120 proceeds to a step 122. Step 122 determines whether user type 64 for user 52b is populated by student user type 74. If user type 64 is populated by student user type 74, step 122 proceeds to a step 123, which initiates populating profile template 55 with student style profile information from the underlying data files 56 relating to user 52b. This may include populating profile template 55 with information such as what school, education goals, or overall work experience is associated with user 52b. If step 122 determines that user type 64 is not populated with student user type 74, step 122 proceeds to a step 124. Step 124 determines whether user type 64 is populated with business user type 76. If so, step 124 proceeds to a step 125 where business specific information from data files 56 is populated into profile template 55 and displayed within profile 54. Business style information may include customer service information or a link to a storefront within social networking system 1 which portrays any products user 52b wishes to offer for sale within social networking system 1. Other business specific data may include the trademark associated with business user 52b or mailing address contact information relating thereto. If step 124 determines that user type 64 is not populated with business user type 76, step 124 proceeds to a step 126. Step 126 retrieves and displays charity information relating to a charity style account which may include current donation drives or goals for the individual underlying charity associated with user 52b. Steps 121, 123, 125, and 126 thereafter proceed to the end of the data flow diagram represented in FIG. 6. Thereafter, profile 54 associated with user 52b is populated with appropriate data from underlying data files 56 for displaying and providing information specific to the underlying style of user 52b. As discussed previously, the general look and layout of profile template 55 remains static for any style user. However, specific information and data relating to the account style and the user style is populated therein based on the underlying user type 64 associated with user 52b. In this way, each profile 54 within social networking system 1 may remain esthetically constant and static throughout the browsing experience which adds efficiency and usability to social networking system 1.

It is a primary feature of the present invention that social networking system 1 provides a procedure for any user 52 which corresponds to a business user type 76 to vend and display products for sale within social networking system 1. By capturing and storing underlying financial information for each user 52, users may purchase products through social networking system 1 seamlessly without entering financial information for either making a payment or receiving a payment between users 52. As such, social networking system 1 provides a virtual shopping mall for each user 52 in that each user may purchase products or donate to charities or conduct other business activities without having to enter financial information with each transaction or remember login information for each underlying business. This represents an enormous leap in the art, in that currently users within any prior art social networking system are required to enter financial information for each transaction within the prior art social networking system, or simply log into each business over the common World Wide Web 30 to purchase goods from that business. This requires a user to store and enter login information for each and every business the user conducts financial transactions with. By storing financial information for each user 52 within social networking system 1, a user 52 simply purchases products seamlessly without having to enter financial information or log in to a specific sub-site or external website to conduct financial transactions.

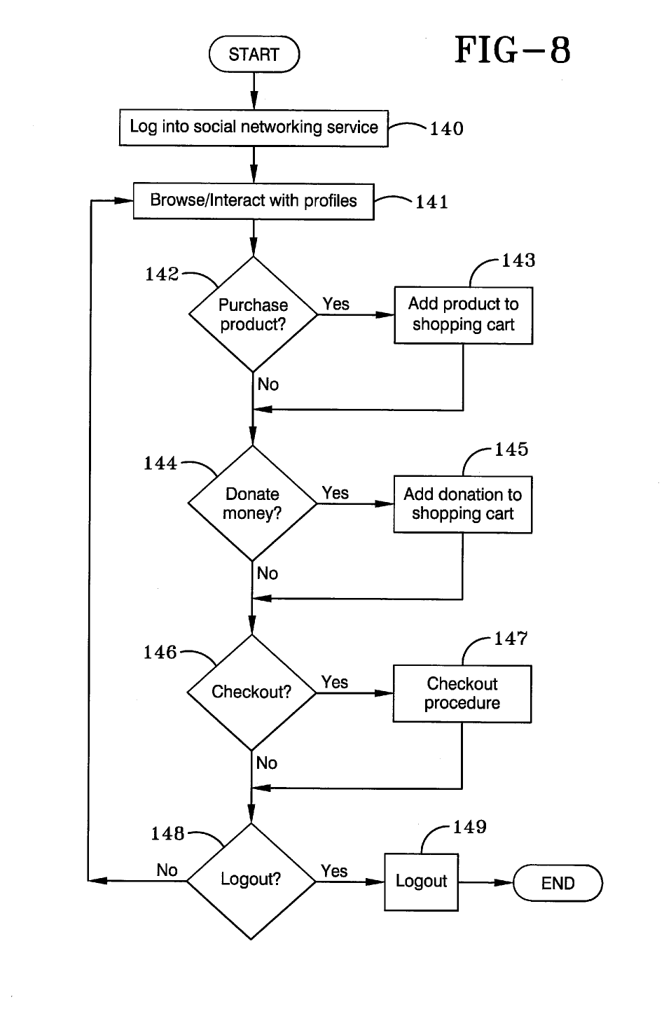

FIG. 7 represents a data flow diagram for a procedure within social networking system 1 for allowing a business style user 52 for uploading product information and vending that product through social networking system 1. As discussed previously, it is a primary feature of the present invention that business style users of social networking system 1 may offer products for sale within the framework of social networking system 1. Pursuant to this, business users 52 follow the procedure represented in FIG. 7 for publishing a product on business user's profile 54. The procedure of FIG. 7 starts with a step 130 wherein the user 52 adds a product name, description, price, the amount of stock of the product, an SKU, and a barcode. One will readily understand that the information added through step 130 is representative only, and is determined by the administrators of social networking system 1. As such, step 130 generally collects any relevant product information for the intended product. Step 130 proceeds to a step 131 where user 52 may upload and add a photograph or diagram of the underlying product. Step 131 proceeds to a step 132 where user 52 is prompted as to whether more photos are necessary or desired. If more photos are desired, step 132 proceeds back to step 131 for adding an additional photograph or diagram. If user 52 determines in step 132 that more photos are not required, step 132 proceeds to a step 133. Step 133 determines whether user 52 wishes to allow a student discount for this product. If user 52 is willing to apply a student discount to the underlying product, step 133 proceeds to a step 134 where the individual discount is collected by social networking system 1 and correlated to the underlying product. For example, if user 52 wishes to provide a 10% student discount each time a student style user purchases this product through social networking system 1, this information is entered within step 134. Steps 133 and 134 both proceed to a step 135, where it is determined whether user 52 wishes to apply a charity credit to the underlying product. A charity credit can be associated with an individual product within social networking system 1 such that when a user purchases the underlying product, a pre-determined donation amount to a particular charity will be transacted within social networking system 1. For example, the underlying product is a book with information on breast cancer awareness, user 52 may wish to associate this product with applying a $1 charity donation to a breast cancer research charity user 52 of social networking system 1. Step 135 determines that user 52 wishes to apply a charity credit, step 135 proceeds to a step 136 where this charity information and the credit information is collected by social networking system 1. If step 135 determines that a charity credit is not desired, step 135 proceeds to a step 137. Further, step 136 proceeds to step 137 after the charity and charity donation is collected. Step 137 adds all of the product information collected in the previous steps to data files 56 within database 42. Thereafter, the underlying product is available for purchase through user 52 and profile 54 associated with user 52 within social networking system 1.

It is intended that pursuant to the above described method for adding products to social networking system 1, a general style or student style user 52a may browse and purchase products from a business user 52b or donate to a charity user 52c. Hereinafter, for clarity, an exemplary general or student user will be referred to as user 52a, an exemplary business user will be referred to as user 52b, and an exemplary charity user will be referred to as user 52c. Once user 52a has entered the appropriate information into social networking system 1 such that user 52a now includes a viewable profile 54a within social networking system 1, user 52a may interact with social networking system 1 by browsing other users' profiles 54 and interacting with said profiles 54. This interaction may be of any type common in the art, such as leaving comments on a particular users profile 54, uploading photographs or other data onto profiles 54 for users 52, or any other interactions common in the art. In addition to such prior art uses for social networking system 1, user 52a may purchase items from business users 52b or donate to charity users 52c through the interface of social networking system 1 during the browsing experience. While the background software elements necessary to facilitate such methods may be implemented in any way in any efficient method desired by the designers of social networking system 1, the primary and preferred embodiment of social networking system 1 uses a virtual shopping cart feature for users 52 to load with desired products, services, or donations. Social networking system 1 thereafter provides the option to checkout and send payments and other purchasing or donation information to the payee/receiver of such payments. A data flow diagram showing such interaction with social networking system 1 is shown in FIG. 8.

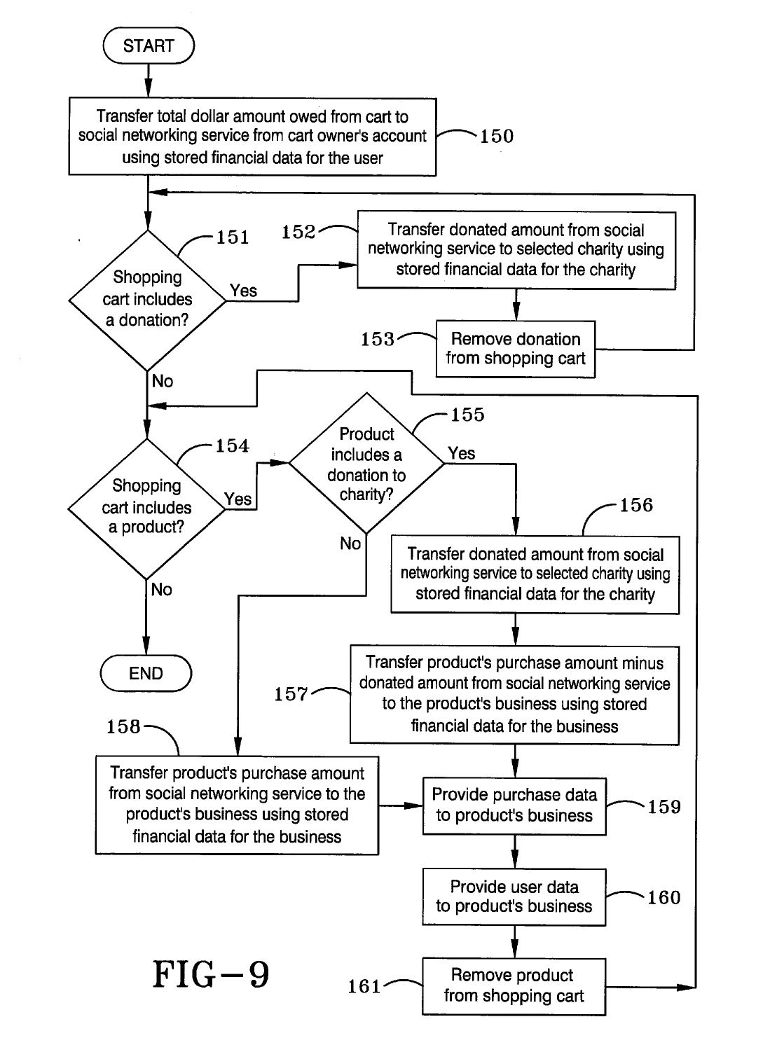

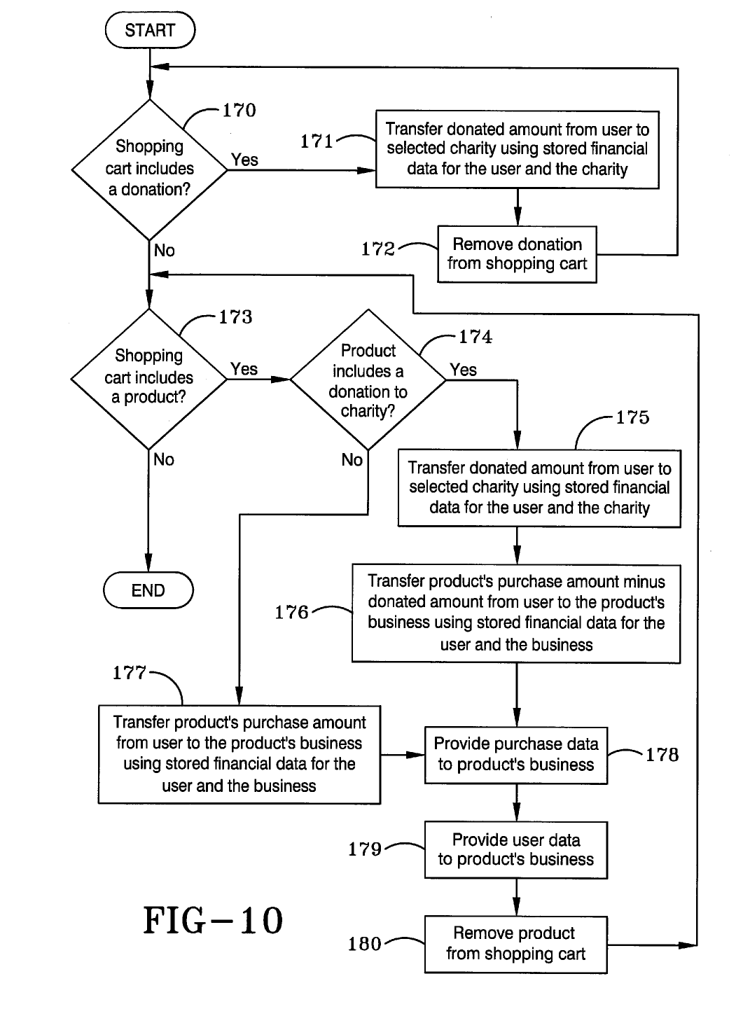

As shown in FIG. 8, a typical interaction with social networking system 1 begins with a step 140 wherein user 52a logs into social networking system 1 using the specified credentials and login information provided when user 52a generated the corresponding account in social networking system 1. Step 140 thereafter proceeds to a step 141, wherein user 52a browses and interacts with the various profiles 54 available on social networking system 1. During these browsing interaction sessions with other profiles 54, should user 52a wish to view various products or services for purchase, step 141 proceeds to a step 142 where user 52a determines whether to purchase a product from user 52b. If it is determined that user 52a desires to purchase a product from user 52b, step 142 proceeds to a step 143 wherein said product is added to the virtual shopping cart associated with user 52a. Thereafter, step 143 proceeds to a step 144. If it is determined in step 142 that the user does not wish to purchase a product, step 142 proceeds to step 144. Step 144 determines if user 52a wishes to donate money to charity user 52c through browsing and interacting with the various profiles 54 on social networking system 1. In step 144, if user 52a does wish to donate to a particular charity, step 144 proceeds to a step 145, wherein said donation amount and other information is added to the shopping cart associated with user 52a. Step 145 thereafter proceeds to a step 146. Similarly, if it is determined within step 144 that the user does not wish to donate money to a particular charity or charities within social networking system 1, step 144 proceeds to step 146. Step 146 queries user 52a as to whether user 52a wishes to initiate a checkout procedure. If step 146 determines that user 52a does wish to checkout, step 146 proceeds to a step 147, wherein a checkout procedure is initiated and completed. Exemplary embodiments of said checkout procedures are shown in FIGS. 9 and 10. If it is determined in step 146 that user 52a does not wish to checkout, step 146 proceeds to a step 148. Similarly, step 147 proceeds to step 148 after the checkout procedure is completed. Step 148 queries user 52a as to whether user 52a wishes to logout of social networking system 1. If so, step 148 proceeds to a step 149, where logout sub-routines are initiated and completed to log user 52a out of social networking system 1. If step 148 determines that user 52a does not wish to logout of social networking system 1, step 148 proceeds back to step 141 wherein user 52a may continue to browse or interact with the various profiles 54 within social networking system 1.

Thus, it will be readily understood that user 52a may browse and interact with profiles 54 within social networking system 1, and while browsing and interacting with said profiles 54, user 52a may add products to a virtual shopping cart, or likewise, add donations to the virtual shopping cart. Thereafter, the user may desire to checkout and pay for said items within the shopping cart all within the framework of social networking system 1. No additional login information or account information is required by social networking system 1. All of the required financial details are stored behind the scenes within data files 43 to facilitate a seamless transaction between user 52a and the desired payee user 52. Further, user 52a is provided with a standardized generally similar framework and layout of each profile 54, such that user 52a may efficiently browse and interact with any of the various profiles 54 within social networking system 1 and find standardized information and other features on every profile 54, regardless of the underlying data displayed thereon. As such, social networking system 1 eliminates the need to store and retrieve numerous account numbers, login credentials, or other vendor-specific information. User 52a simply clicks through all of the available payee profiles 54, adding elements, products, and/or donations to a virtual shopping cart, and paying for said items as desired and without the need for additional financial or account information.

As shown in FIGS. 9 and 10, social networking system 1 may incorporate two distinct styles of implementing a checkout procedure. As shown in FIG. 9, a first method of incorporating a checkout procedure is shown and described in a data flow diagram, wherein when user 52a wishes to initiate the checkout procedure, the total dollar amount owed from the items within the shopping cart of user 52a is transferred from user 52a to social networking system 1. Thereafter, the individual payee users 52 associated with the purchased products or donations are paid from social networking system 1 in the dollar amount transferred from the payor thereto. This represents one overall business model which social networking system 1 may incorporate, as social networking system 1 may act as an intermediary to the financial transaction. As such, social networking system 1, by implementing the checkout procedure shown in FIG. 9, may retain a small percentage of the amount transferred between the payor user and the payee user. For example, if the items in a shopping cart associated with user 52a require user 52a to pay an amount of $100 to the various payees associated with the items in the shopping cart, social networking system 1 may extract a 1% fee in addition to this $100, making the total transfer from user 52a to social networking system 1 $101. Thereafter, social networking system 1 pays the individual payee users 52a the amount of $100 in the aggregate. Thus, social networking system 1 retains the 1% fee of $1 pursuant to the business model and checkout procedure shown in FIG. 9. Alternatively, social networking system 1 may opt to deduct the 1% fee from the payees by subtracting $1 from the amount owed the payees and prorate this fee accordingly with the amount owed to each individual payee.

As shown in FIG. 9, the first checkout procedure shown and described therein starts with a step 150 where social networking system 1 transfers the total dollar amount owed from a shopping cart associated with a user 52a from the account of user 52a to social networking system 1 using the stored financial data for user 52a. Step 150 may also include adding and receiving an additional fee from user 52a for facilitating this transfer. After a dollar amount is transferred from user 52a to social networking system 1, step 150 proceeds to a step 151. Step 151 determines whether the shopping cart associated with user 52a includes a donation. If the shopping cart includes a donation, step 151 proceeds to a step 152. If the shopping cart does not include a donation, step 151 proceeds to a step 154. In step 152, the donation amount is transferred from social networking system 1 to the selected charity user 52c associated with the donation using stored financial data for charity user 52b. Once charity user 52c has been credited with the proper amount donated by user 52a, step 152 proceeds to a step 153. Step 153 removes the donation from the shopping cart and proceeds back to step 151 thereafter. This loop of step 151 to step 152 to step 153 back to step 151 continues until all of the donations in the shopping cart have been credited to the individual charities associated therewith. Once all donations have been removed and applied from the shopping cart, step 151 proceeds to step 154. Step 151 queries whether the shopping cart associated with user 52a includes a product for purchase. If the shopping cart does include at least one product for purchase, step 154 proceeds to a step 155. Step 155 determines whether the product includes an associated donation to a charity. If so, step 155 proceeds to a step 156. If step 155 determines that the product does not include a donation to charity, step 155 proceeds to a step 158. Step 156 transfers the donated amount associated with the product from social networking system 1 to a charity user 52c associated with the donation using stored financial data for the charity user 52c. Thus, in step 156, the charity is credited for the donation associated with a user 52a purchasing the particular product. As discussed previously, products offered for sale within social networking system 1 may be associated with a donation to a charity user 52c of social networking system 1. Thus, the checkout procedure for social networking system 1 includes logic for accounting this donation during the checkout procedure. Step 156 proceeds to a step 157 where the product's purchase amount minus the donated amount from step 156 is transferred from social networking system 1 to a business user 52b associated with the product, using the stored financial data for business user 52b. Thereafter, step 157 proceeds to a step 159. Step 158 is similar in most respects to step 157, as the product's purchase amount is transferred from social networking system 1 to the business user 52b associated with the product being purchased, based on stored financial data 66b for business user 52b. In step 158, no donation amount is subtracted from the purchase amount as it was determined in step 155 that this product does not include a donation to a charity. Step 158 thereafter proceeds to step 159. Step 159 provides purchase data to business user 52b associated with the product being purchased. This information may include any relevant data associated with the product, including sizing information, color information, style, or any other relevant data associated with the product. Step 159 thereafter proceeds to a step 160 where user data for the purchasing user 52a is provided to business user 52b, including shipping address and other data associated with user 52a. Step 160 proceeds to a step 161 where the product is removed from the shopping cart associated with user 52a. Step 161 thereafter proceeds back to step 154. This loop continues until all of the products have been removed and accounted for within the shopping cart associated with user 52a. Thereafter, step 154 terminates the checkout procedure.

While one of the features of the checkout procedure shown and described in FIG. 9 includes extracting a small checkout fee from user 52a, a fee may also or alternatively be extracted from business user 52b. As shown in steps 157 and 158, the product's purchase amount is transferred from social networking system 1 to business user 52b. During this transfer, the present invention includes the method of extracting a fee from the purchase amount before the remaining amount is transferred to business user 52b. Thus, a fee may be extracted from either the purchaser or payor user 52a of social networking system 1 as an additional fee added to the checkout amount, and/or has a fee subtracted from the purchase amount due to the business payee user 52b. Thus, social networking system 1 may profit from each transaction either by applying a fee to the purchasor and/or applying a fee to the purchasee, for every transaction. This represents a non-advertising based model for social networking system 1, wherein social networking system 1 and the profiles 54 displayed therein may not incorporate advertisements or other marketing elements to produce revenue for social networking system 1. Revenue is generated by nominal fees either extracted from the payor or the payee, or both, during a financial transaction conducted and facilitated by social networking system 1. FIG. 10 represents an alternative embodiment of a checkout procedure described as the second checkout procedure. The second checkout procedure shown and described in FIG. 10 generally includes transferring payments and donations directly from a user 51a to a corresponding business user 52b or charity user 52c. This direct transfer of payments or donations is facilitated by social networking system 1 using the stored financial data for user 52a, business user 52b or charity user 52c. The second checkout procedure shown and described in FIG. 10 starts with a step 170 where social networking system 1 determines whether the shopping cart associated with user 52a includes a donation. If step 170 determines that the shopping cart does include a donation, step 170 proceeds to a step 171. Step 171 transfers the donated amount from user 52a to the selected charity user 52c associated with the donation, using stored financial data for user 52a and charity user 52c. Thereafter, step 171 proceeds to a step 172, wherein the donation is removed from the shopping cart. Thereafter, step 172 proceeds back to step 170 for determining whether additional donations reside in the shopping cart. When all of the donations have been removed and accounted for, step 170 proceeds to a step 173. Step 173 determines whether the shopping cart includes a product for purchase. If the shopping cart does not include a product for purchase, the second checkout procedure of FIG. 10 is terminated. If step 173 determines that the shopping cart includes a product for purchase, step 173 proceeds to a step 174. Step 174 determines whether the product is associated with a donation to a charity. If so, step 174 proceeds to a step 175. Step 175 proceeds to transfer the donated amount associated with the product from user 52a to the selected charity user 52c using stored financial information for user 52a and charity user 52c. Thereafter, step 175 proceeds to a step 176, wherein the product's purchase amount is offset by the donated amount and this new offset amount for the product is transferred from user 52a to the business user 52b associated with the product. The offset amount is transferred using stored financial data for user 52a and business user 52b. Step 176 proceeds thereafter to a step 176. If step 174 determines that the product does not include a donation to a charity, step 174 proceeds to a step 177. Step 177 transfers the product's purchase amount from user 52a to the business user 52b associated with the product being purchased. The product's purchase amount is transferred using stored financial data for user 52a and business user 52b. Thereafter, step 177 proceeds to step 178. Step 178 provides purchase data to business user 52b associated with the product being purchased. This information may include any relevant data associated with the product, including sizing information, color information, style, or any relevant data associated with the product. Step 178 thereafter proceeds to a step 179, where user data for the purchasing user 52a is provided to business user 52b, including shipping address and other relevant data associated with user 52a. Step 179 thereafter proceeds to a step 180, where the product is removed from the shopping cart. Step 180 proceeds back to step 173 and this overall loop is iterated until the shopping cart is empty.

The second checkout procedure shown and described in FIG. 10, represents an advertising based model for social networking system 1, wherein social networking system 1 generates revenue by displaying advertisements on profiles 54 throughout social networking system 1. Thus, inasmuch as revenue is generated through advertising means, fees are not extracted or accessed for transferring payments between users. Revenue is generated by advertiser users 52 displaying ads throughout social networking system 1, and providing payments to social networking system 1 for the display of these ads.

One will readily understand from the foregoing that new users and current users 52 are attracted to social networking system 1 due to the high level of convenience provided for viewing and paying for products or donations. This high level of convenience comes from the ability to pay for products or services through the underlying structure of social networking system 1 without having to logout or reenter financial data to complete a purchase or make a donation. It is intended that business users 52b will similarly enjoy a high level of convenience in that products may be added and removed via a simple interface provided by social networking system 1 and generally shown in FIG. 7. Business users 52b are provided the opportunity to add their products to a ready-made virtual shopping mall without the need to hire graphic designers or design a website independently. The structure and overall layout of profiles 54 associated with business users 52b and charity users 52c is generally set and static within social networking system 1, leaving users 52b and 52c to concentrate on products, product descriptions, photographs, and the like.

In the foregoing description, certain terms have been used for brevity, clearness, and understanding. No unnecessary limitations are to be implied therefrom beyond the requirement of the prior art because such terms are used for descriptive purposes and are intended to be broadly construed.

Moreover, the description and illustration of the invention is an example and the invention is not limited to the exact details shown or described.

1. A method of facilitating a social networking system, the method comprising the steps of:
creating a pool of users for the social networking system, wherein each user is associated with a set of public data, a set of financial data, and a profile for displaying the set of public data;
partitioning the pool of users into a group of general users, a group of student users, a group of business users, and a group of charity users;
allowing the group of general users and the group of student users to selectively purchase a product from the group of business users through the social networking system; and
allowing the group of general users and the group of student users to selectively transfer a donation to the group of charity users through the social networking system.

2. The method of claim 1, wherein the set of public data associated with each user in the group of business users includes a collection of products available for purchase through the social networking system.

3. The method of claim 2, further comprising the step of displaying the collection of products on the profile of the associated user in the group of business users.

4. The method of claim 1, wherein the set of public data associated with each user in the group of charity users includes a donation amount available for donating through the social networking system.

5. The method of claim 1, further comprising the step of using a first set of financial data associated with a first user and a second set of financial data associated with a second user to facilitate a transfer of funds from the first user to the second user.

6. The method of claim 5, wherein the first set of financial data is a credit card number.

7. The method of claim 6, wherein the second set of financial data is a back account routing number.

8. The method of claim 1, further comprising the steps of:
associating a price with a product offered for sale in the social networking system; and
applying a discount to the price when a user in the group of student users purchases the product.

9. The method of claim 1, further comprising the steps of:
associating a price with a product offered for sale in the social networking system;
associating a donation amount with the product; and
transferring the donation amount to one of the group of charity users when one of the users in the pool of users purchases the product.

10. A method comprising:
allowing a first user of a social networking system to associate with a set of other users within the social networking system;
allowing the first user to view a profile of a second user of the social networking system;
offering a collection of products for sale by the second user through the social networking system by displaying the collection of products on the profile;
selecting a product in the collection of products for purchase by the second user, wherein the product is associated with a price;
transferring an amount of money equal to the price from the first user to the second user through the social networking system; and
transferring the product from the second user to the first user.

11. The method of claim 10, further comprising the step of using a first set of financial data associated with the first user to transfer the amount from the first user to the second user.

12. The method of claim 11, further comprising the step of using a second set of financial data associated with the second user to receive the transfer of the amount from the first user to the second user.

13. The method of claim 12, further comprising the steps of:
determining whether the first user is a student user; and
transferring a discounted amount of money equal to less than the price from the first user to the second user through the social networking system when the first user is a student user.

14. The method of claim 12, wherein the first set of financial data is a credit card number and the second set of financial data is a bank account routing number.

15. The method of claim 10, further comprising the step of allowing the second user to configure which products are in the collection of products.

16. The method of claim 15, further comprising the step of allowing the second user to configure what prices are associated with each product in the collection of products.

17. The method of claim 10, further comprising the steps of:
allowing the first user to view a profile of a third user of the social networking system;
determining a donation amount by the first user; and
transferring an amount of money equal to the donation amount from the first user to the third user through the social networking system.

18. An apparatus comprising:
one or more processors;
a memory comprising instructions executable by the one or more processors; and
the one or more processors coupled to the memory and operable to execute instructions, the one or more processors being operable when executing the instructions to:
maintain a set of payor users of the social networking system;
maintain a set of payee users of the social networking system;
associate a payor financial dataset for each payor user;
use the payor financial datasets to provide payments to payee users as requested; and
create an association between two payor users, wherein the association enables social interactions between the two payor users.

19. The apparatus of claim 18, the one or more processors being further operable when executing the instructions to:
associate a payee financial dataset for each payee user; and
use the payee financial datasets in receiving payments from payor users as requested.

20. The apparatus of claim 19, the one or more processors being further operable when executing the instructions to:
associate a first product with a first payee user in the set of payee users;
associate a price for the first product; and
provide a first payment in the amount of the price to the first payee user, wherein the first payment is provided by a first payor user in the set of payor users.
